(19) United States
(12) Patent Application Publication
(10) Pub. No.: US 2023/0144337 A1
(43) Pub. Date: May 11, 2023

(54) METHOD AND SYSTEM FOR MANAGING RADIO UNIT (RU) SUPERVISION FAILURE IN O-RAN

(71) Applicant: Sterlite Technologies Limited, Gurugram (IN)

(72) Inventors: Nitin Kumar, Gurugram (IN); Manish Jamwal, Gurugram (IN); Gurpreet Singh, Gurugram (IN); Savnish Singh, Gurugram (IN)

(73) Assignee: Sterlite Technologies Limited, Gurugram (IN)

(21) Appl. No.: 17/705,246

(22) Filed: Mar. 25, 2022

(30) Foreign Application Priority Data
Nov. 9, 2021 (IN) 202111051262

(51) Int. Cl. H04W 36/30; H04W 24/04; H04L 41/0668

(52) U.S. Cl. CPC H04W 36/305; H04W 24/04; H04L 41/0668

(57) ABSTRACT

The present disclosure provides a method and a system for managing radio unit or Open-Radio Unit (O-RU) (116) failure. The method manages the O-RU failure through a plurality of NETCONF (Network Configuration Protocol) clients by a management-plane (M-Plane) in an open radio access network (100). The method includes establishing the M-Plane between the O-RU and the plurality of NETCONF clients available with each of an Open-Distributed Unit (O-DU) (114) and a Service Management and Orchestration (SMO) framework (102) and detecting failure by the plurality of NETCONF clients in the connection between the O-RU and the plurality of NETCONF clients within a session at a predefined time duration. Lastly, the method includes switching the connection from a hybrid model to a hierarchical model in case of the failure with the hybrid model, whereby switching the connection ensures returning to the hybrid model without reset when the SMO framework connection is back.

### TECHNICAL FIELD

The present disclosure relates to a wireless communication system, and more specifically relates to a supervision fault/failure management system and method for a radio unit (RU) of a base station in Open-Radio Access Network (ORAN)

### BACKGROUND

In an Open-Radio Access Network (ORAN), management functions of an Open Radio Unit (O-RU) are done over an M-Plane (management-plane), where Network Configuration Protocol (NETCONF) servers and NETCONF clients are connected through operator, observer, or “sudo” connection(s) (e.g., connection(s) of other user account) within a session. At some default time, the “sudo” connection(s) (or connection(s)) need to be checked whether they are broken or not. Such default time is called as supervision notification time. If any failure/fault in the connection(s) within the supervision notification time (“called as supervision failure condition or supervision failure”) is detected by the O-RU (or RU) and at that time, if all NETCONF sessions to the NECTONF clients with “sudo” privileges are closed, the O-RU immediately disables the operation of a supervision watchdog timer and immediately ceases RF (radio frequency) transmissions and performs an autonomous recovery reset procedure.

Consequently, the aforesaid procedure triggers re-initialization of the transport layer and re-commencement of start-up installation procedures, even though a hierarchical connection to an Open Distributed Unit (O-DU) with a working CUSM Plane (i.e., Control Plane, User Plane, Synchronization Plane, Management Plane) is present. If any changes had been done before the O-RU reset for correct RF transmissions, such changes will be lost. Also, any security configuration, that had been done before, will be reset, leaving the network/O-RU open to attackers. Some of the prior art references are given below:

CN111490893A relates to a method for establishing a network forwarding model which are used for solving the problem of poor expansibility of a method for establishing the network forwarding model by control equipment. The control device with an Intent Based Network System (IBNS) sends a Netconf request message to at least two network devices through a network configuration protocol (Netconf), wherein the Netconf request message comprises a message identifier for uniquely identifying the Netconf request message, a data type, and an acquisition identifier for indicating that acquisition of data corresponding to the data type is requested. The control device receives a Netconf response message sent by each network device, wherein the Netconf response message comprises the message identification and data corresponding to the data type. The control device acquires data sent by each network device and establishes a network forwarding model for verifying a network formed by the at least two network devices according to the acquired data.

U.S. Pat. No. 10,644,942 B2 discloses a system, method, and interfaces for Radio Access Networks and Cloud Radio Access Networks and focuses on the design of operation, administration, and management of various network elements of 4G and 5G based mobile networks. U.S. Pat. No. 10,644,942 B2 provides embodiments that leverage various capabilities of Network Configuration Protocol (NETCONF) protocol and YANG data modelling language to provide flexibility of various management functions of RAN network entities. The NETCONF protocol provides mechanisms to install, manipulate, and delete the configuration of network devices. It uses an Extensible Markup Language (XML)-based data encoding for the configuration data as well as the protocol messages. The NETCONF protocol operations are realized as remote procedure calls (RPCs).

While the prior arts cover various solutions for fault/failure management of the O-RU, however these solutions are not suitable due to implementation of reset procedure during supervision failure. In light of the above-stated discussion, there is a need to overcome the above stated disadvantages.

### OBJECT OF THE DISCLOSURE

A principal object of the present disclosure is to provide a method and a system for managing radio unit (RU) faults/failure, i.e., supervision failure.

Another object of the present disclosure is to provide the RU (or Open Radio unit) to facilitate NETCONF (Network Configuration Protocol) CLIENT through Yang Model while connection failure.

Yet another object of the present disclosure is to switch to a hierarchical model (hierarchical connection) from a hybrid model (hybrid connection) in case of the supervision failure with a Service Management and Orchestration (SMO)/Network Management System (NMS) and to reconnect (call home) for the hybrid connection to the SMO by returning to the hybrid connection without a reset, once the SMO/NMS connection is back.

### SUMMARY

Accordingly, the present disclosure provides a method and a system for managing Open Radio Unit (O-RU) supervision failure through a plurality of NETCONF (Network Configuration Protocol) clients by a management-plane (M-Plane) in an open radio access network (ORAN).

The method includes O-RU (i.e., NETCONF server) and the plurality of NETCONF clients available with each of an Open Distributed Unit (O-DU) and a Service Management and Orchestration (SMO) framework. In O-RAN, the O-RU and the plurality of NETCONF clients management functions, to set parameters are done over the M-Plane, wherein various parameters are as data models to achieve the required management operation as like O-RU parameter, set/get for configuration management, wherein the management functions include O-RU software management, fault management etc.

The connection is established via a NETCONF interface, where the NETCONF interface comprising at least one of: a fault management interface, a software management interface, a configuration management interface and a performance management interface. The NETCONF server of the O-RU interfaces with the NETCONF client of the SMO framework.

The method establishes the NETCONF interface between the SMO framework and the O-RU by establishing a transport layer between the O-RU and the SMO framework via the O-DU and establishing the NETCONF interface between the NETCONF client of the SMO framework and the NETCONF server of the O-RU.

At the established M-Plane, the method detects failure by the plurality of NETCONF clients in the connection between the O-RU and the plurality of NETCONF clients within a session at a predefined time duration, where the session is accompanied by an exchange of messages. The O-DU and the SMO framework manage the O-RU in the M-Plane using NETCONF, where the O-DU and the SMO framework each corresponds to a NETCONF client while the O-RU corresponds to a NETCONF server. The method further includes switching the connection from a hybrid model to a hierarchical model in case of the failure with the hybrid model, whereby switching the connection ensures returning to the hybrid model without reset when connection of the SMO framework is back, thereby saving a prior implemented security configuration in the O-RU.

During connection of the hierarchical model, a NETCONF client is configured to network with the O-DU and the O-DU manages the NETCONF server and in connection of the hybrid model, the O-RU is managed by the plurality of NETCONF clients each corresponding to the O-DU and the SMO framework and SMO Client interfaces with the O-DU and the O-RU both.

While switching the connection from the hybrid model to the hierarchical model when the O-RU enters in failure condition, the session ends between the NETCONF client and the NETCONF server due to expiration of the session at the predefined time duration and a session close command received from the NETCONF client.

In an implementation, switching of the connection from the hybrid model to the hierarchical model is done by retrieving information of all lost connections and information of reconnection of the hybrid model to the NETCONF client stored in a YANG (Yet Another Next Generation) model and deploying the information from the YANG model to the hierarchical model while switching the connection as a setting of required parameters is specified in form of the YANG model.

Similarly, switching of the connection from the hierarchical model to the hybrid model, when the connection of the SMO framework is back, is done by retrieving connection details from the YANG model and deploying the connection details in the hierarchical model.

The method further includes updating the connection details of the NETCONF client of the SMO framework at the YANG model of the O-RU and start sending notifications with the connection details to the plurality of NETCONF clients.

These and other aspects herein will be better appreciated and understood when considered in conjunction with the following description and the accompanying drawings. It should be understood, however, that the following descriptions are given by way of illustration and not of limitation. Many changes and modifications may be made within the scope of the invention herein without departing from the spirit thereof.

### BRIEF DESCRIPTION OF FIGURES

The invention is illustrated in the accompanying drawings, throughout which like reference letters indicate corresponding parts in the drawings. The invention herein will be better understood from the following description with reference to the drawings, in which:

FIG. 1 illustrates an O-RAN (Open-Radio Access Network) system according to present disclosure.

FIG. 2a illustrates a hierarchical model used in FIG. 1.

FIG. 2b illustrates a hybrid model used in FIG. 1.

FIG. 3 is sequence diagram for supervising/monitoring connectivity between a NETCONF (Network Configuration Protocol) server and a NETCONF client.

FIG. 4 is sequence diagram illustrating switching between the hierarchical model and the hybrid model during supervision failure (or connection failure).

FIG. 5 illustrates various hardware elements of an O-DU/SMO to manage O-RU (or RU) faults and failures through NETCONF client by a management plane (M-Plane) through YANG model.

FIG. 6 is a flowchart illustrating a fault/failure management method for the radio unit (RU).

### DETAILED DESCRIPTION

In the following detailed description of the invention, numerous specific details are set forth in order to provide a thorough understanding of the invention. However, it will be obvious to a person skilled in the art that the invention may be practiced with or without these specific details. In other instances, well known methods, procedures and components have not been described in details so as not to unnecessarily obscure aspects of the invention.

Furthermore, it will be clear that the invention is not limited to these alternatives only. Numerous modifications, changes, variations, substitutions and equivalents will be apparent to those skilled in the art, without parting from the scope of the invention.

The accompanying drawings are used to help easily understand various technical features and it should be understood that the alternatives presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Standard networking terms and abbreviation: Active bearer: An active bearer corresponds to tunnel connections between the UE and a packet data network gateway to provide a service.

QoS Class identifier (QCI): QCI level corresponds to a QoS value required by an active bearer in the UE to provide the service.

gNB: New Radio (NR) Base stations which have capability to interface with 5G Core named as NG-CN over NG-C/U (NG2/NG3) interface as well as 4G Core known as Evolved Packet Core (EPC) over S1-CU interface.

LTE eNB: An LTE eNB is evolved eNodeB that can support connectivity to EPC as well as NG-CN.

Non-standalone NR: It is a 5G Network deployment configuration, where a gNB needs an LTE eNodeB as an anchor for control plane connectivity to 4G EPC or LTE eNB as anchor for control plane connectivity to NG-CN.

Standalone NR: It is a 5G Network deployment configuration where gNB does not need any assistance for connectivity to core Network, it can connect by its own to NG-CN over NG2 and NG3 interfaces.

Non-standalone E-UTRA: It is a 5G Network deployment configuration where the LTE eNB requires a gNB as anchor for control plane connectivity to NG-CN.

Standalone E-UTRA: It is a typical 4G network deployment where a 4G LTE eNB connects to EPC.

Xn Interface: It is a logical interface which interconnects the New RAN nodes i.e., it interconnects gNB to gNB and LTE eNB to gNB and vice versa.

Reference signal received power (RSRP): RSRP may be defined as the linear average over the power contributions (in [W]) of the resource elements that carry cell-specific reference signals within the considered measurement frequency bandwidth.” RSRP may be the power of the LTE Reference Signals spread over the full bandwidth and narrowband.

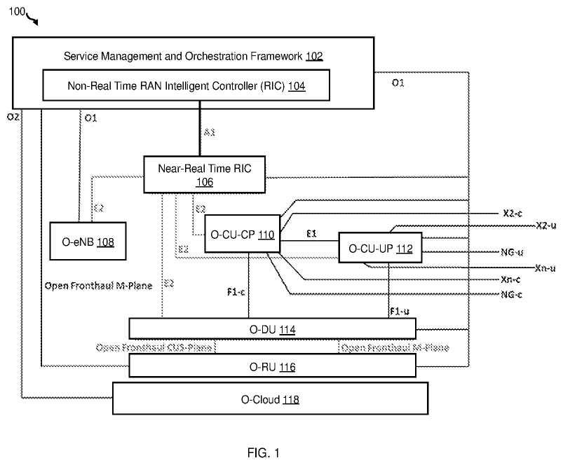

Referring now to the drawings, and more particularly to FIGS. 1 through 6.

FIG. 1 illustrates an O-RAN system (or O-RAN) 100 according to present disclosure.

A radio access network (RAN) is a part of a telecommunications system which connects individual devices to other parts of a network through radio connections. The RAN provides a connection of user equipment (UE) such as mobile phone or computer with a core network of the telecommunication systems. The RAN is an essential part of access layer in the telecommunication systems which utilizes base stations (such as e node B, g node B) for establishing radio connections. The O-RAN (Open-Radio Access Network) 100 is an evolved version of prior radio access networks, makes the prior radio access networks more open and smarter than previous generations. The O-RAN provides real-time analytics that drive embedded machine learning systems and artificial intelligence back end modules to empower network intelligence. Further, the O-RAN includes virtualized network elements with open and standardized interfaces. The open interfaces are essential to enable smaller vendors and operators to quickly introduce their own services, or enables operators to customize the network to suit their own unique needs. Open interfaces also enable multivendor deployments, enabling a more competitive and vibrant supplier ecosystem. Similarly, open-source software and hardware reference designs enable faster, more democratic and permission-less innovation. Further, the O-RAN introduces a self-driving network by utilizing new learning-based technologies to automate operational network functions. These learning-based technologies make the O-RAN intelligent. Embedded intelligence, applied at both component and network levels, enables dynamic local radio resource allocation and optimizes network wide efficiency. In combination with O-RAN's open interfaces, AI-optimized closed-loop automation is a new era for network operations.

The O-RAN 100 may comprise a Service Management and Orchestrator (SMO) (can also be termed as “Service Management and Orchestration Framework”) 102, a Non-Real Time RAN Intelligent Controller (Non-RT-RIC) 104 residing in the SMO 102, a Near-Real Time RAN Intelligent Controller (Near-RT-RIC) 106, an Open Evolved NodeB (O-eNB) 108, an Open Central Unit Control Plane (O-CU-CP) 110, an Open Central Unit User Plane (O-CU-UP) 112, an Open Distributed Unit (O-DU) 114, an Open Radio Unit (O-RU) 116 and an Open Cloud (O-Cloud) 118.

The SMO 102 is configured to provide SMO functions/services such as data collection and provisioning services of the ORAN 100. The data collection of the SMO 102 may include, for example, data related to a bandwidth of a wireless communication network and at least one of a plurality of user equipments (not shown in figures). That is, the SMO 102 oversees all the orchestration aspects, management and automation of ORAN elements and resource and supports O1, A1 and O2 interfaces.

The Non-RT-RIC 104 is a logical function that enables non-real-time control and optimization of the ORAN elements and resources, AI/ML workflow including model training and updates, and policy-based guidance of applications/features in the Near-RT RIC 106. It is a part of the SMO Framework 102 and communicates to the Near-RT RIC using the A1 interface. The Near-RT-RIC 106 is a logical function that enables near-real-time control and optimization of the O-RAN elements and resources via fine-grained data collection and actions over E2 interface.

Non-Real Time (Non-RT) control functionality (>1 s) and Near-Real Time (Near-RT) control functions (<1 s) are decoupled in an RIC (RAN Intelligent Controller). The Non-RT functions include service and policy management, RAN analytics and model-training for some of the near-RT RIC functionality, and non-RT RIC optimization.

The O-eNB 108 is hardware aspect of a fourth generation RAN that communicates with at least one of the plurality of user equipments (not shown in figures) via wireless communication networks such as a mobile phone network. The O-eNB 108 is a base station and may also be referred to as e.g., evolved Node B (“eNB”), “eNodeB”, “NodeB”, “B node”, gNB, or BTS (Base Transceiver Station), depending on the technology and terminology used. The O-eNB is a logical node that handles transmission and reception of signals associated with a plurality of cells (not shown in figures). The O-eNB 108 supports O1 and E2 interfaces to communicate with the SMO 102 and the Near-RT-RIC 106 respectively.

Further, an O-CU (Open Central Unit) is a logical node hosting RRC (Radio Resource Control), SDAP (Service Data Adaptation Protocol) and PDCP (Packet Data Convergence Protocol). The O-CU is a disaggregated O-CU and includes two sub-components: O-CU-CP 110 and O-CU-UP 112. The O-CU-CP 110 is a logical node hosting the RRC and the control plane part of the PDCP. The O-CU-CP 110 supports O1, E2, F1-c, E1, X2-c, Xn-c and NG-c interfaces for interaction with other components/entities.

Similarly, the O-CU-UP 112 is a logical node hosting the user plane part of the PDCP and the SDAP and uses O1, E1, E2, F1-u, X2-u, NG-u and Xn-u interfaces.

The O-DU 114 is a logical node hosting RLC/MAC (Medium access control)/High-PHY layers based on a lower layer functional split and supports O1, E2, F1-c, F1-u, OFH CUS-Plane and OFH M-Plane interfaces.

The O-RU 116 is a logical node hosting Low-PHY layer and RF (Radio Frequency) processing based on a lower layer functional split. This is similar to 3GPP's “TRP (Transmission And Reception Point)” or “RRH (Remote Radio Head)” but more specific in including the Low-PHY layer (FFT/iFFT, PRACH (Physical Random Access Channel) extraction). The O-RU 116 utilizes OFH CUS-Plane and OFH M-Plane interfaces.

The O-Cloud 118 is a collection of physical RAN nodes (that host various RICs, CUs, and DUs), software components (such as operating systems and runtime environments) and the SMO 102, where the SMO manages and orchestrates the O-Cloud 118 from within via O2 interface.

Now referring to the various interfaces used in the ORAN 100 as mentioned above.

The O1 interface is element operations and management interface between management entities in the SMO 102 and O-RAN managed elements, for operation and management, by which FCAPS (fault, configuration, accounting, performance, security) management, Software management, File management shall be achieved. The O-RAN managed elements include the Near RT-RIC 106, the O-CU (the O-CU-CP 110 and the O-CU-UP 112), the O-DU 114, the O-RU 116 and the O-eNB 108. The management and orchestration functions are received by the aforesaid O-RAN managed elements via the O1 interface. The SMO 102 in turn receives data from the O-RAN managed elements via the O1 interface for AI model training.

The O2 interface is a cloud management interface, where the SMO 102 communicates with the O-Cloud 118 it resides in. Typically, operators that are connected to the O-Cloud 118 can then operate and maintain the O-RAN 100 with the O1 or O2 interfaces.

The A1 interface enables communication between the Non-RT-RIC 104 and the Near-RT-RIC 106 and supports policy management, machine learning and enrichment information transfer to assist and train AI and machine learning in the Near-RT-RIC 106.

The E1 interface connects the two disaggregated O-CUs i.e., the O-CU-CP 110 and the O-CU-UP 112 and transfers configuration data (to ensure interoperability) and capacity information between the O-CU-CP 110 and the O-CU-UP 112. The capacity information is sent from the O-CU-UP 112 to the O-CU-CP 110 and includes the status of the O-CU-UP 112.

The Near-RT-RIC 106 connects to the O-CU-CP 110, the O-CU-UP 112, the O-DU 114 and the O-eNB 108 (combinedly called as an E2 node) with the E2 interface for data collection. The E2 node can connect only to one Near-RT-RIC, but one Near-RT-RIC can connect to multiple E2 nodes. Typically, protocols that go over the E2 interface are control plane protocols that control and optimize the elements of the E2 node and the resources they use.

The F1-c and F1-u interfaces (combinedly an F1 interface) connect the O-CU-CP 110 and the O-CU-UP 112 to the O-DU 114 to exchange data about frequency resource sharing and network statuses. One O-CU can communicate with multiple O-DUs via F1 interfaces.

Open fronthaul interfaces i.e., the OFH CUS-Plane (Open Fronthaul Control, User, Synchronization Plane) and the OFH M-Plane (Open Fronthaul Management Plane) connect the O-DU 114 and the O-RU 116. The OFH CUS-Plane is multi-functional, where the control and user features transfer control signals and user data respectively and the synchronization feature synchronizes activities between multiple RAN devices. The OFH M-Plane optionally connects the O-RU 116 to the SMO 102. The O-DU 114 uses the OFH M-Plane to manage the O-RU 116, while the SMO 102 can provide FCAPS (fault, configuration, accounting, performance, security) services to the O-RU 116.

An X2 interface is broken into the X2-c interface and the X2-u interface. The former is for the control plane and the latter is for the user plane that send information between compatible deployments, such as a 4G network's eNBs or between an eNB and a 5G network's en-gNB.

Similarly, an Xn interface is also broken into the Xn-c interface and the Xn-u interface to transfer control and user plane information respectively between next generation NodeBs (gNBs) or between ng-eNBs or between the two different deployments.

The NG-c (control plane interface) and the NG-u (user plane interface) connect the O-CU-CP 110 and the O-CU-UP 112 respectively to a 5G core. The control plane information is transmitted to a 5G access and mobility management function (AMF) that receives connection and session information from the user equipment and the user plane information is relayed to a 5G user plane function (UPF), which handles tunnelling, routing and forwarding, for example.

Now referring to the SMO 102, the O-DU 114 and the O-RU 116. In management plane (M-Plane), the O-DU 114 and the SMO 102 are used to manage the O-RU 116 (or O-RUs), wherein the O-DU 114 and the SMO 102 use NETCONF (Network Configuration Protocol) to manage the O-RU 116. Alternatively, the O-DU 114 and other NMSs (Network Management Systems) may manage the O-RU 116 via NETCONF. In such a case, the SMO 102 (or the NMS) corresponds to a NETCONF client while the O-RU 116 corresponds to a NETCONF server and the O-DU 114 can act as both the NETCONF client and the NETCONF server depending on the model (explained below).

In general, NETCONF is a network management protocol defined by the Internet Engineering Task Force to manage, install, manipulate, and delete the configuration of network devices. NETCONF operations are realized on top of a Remote Procedure Call (RPC) layer using an XML (Extensible Markup Language) encoding and provide a basic set of operations to edit and query configuration on a network device. NETCONF runs primarily over Secure Shell (SSH) transport. The protocol messages are exchanged on the top of a secure transport protocol. Further, NETCONF reports management information that is useful to NNMi (Network Node Manager i). In terms of SDN (Software Defined Networks), NETCONF is usually referenced as a southbound API (Application Programming Interface) from an SDN controller to network agents like switches and routers due to its potential for supporting multi-vendor environments.

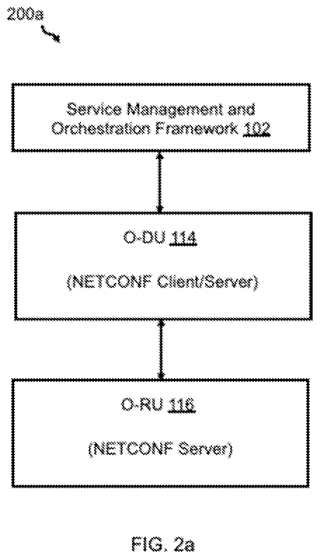

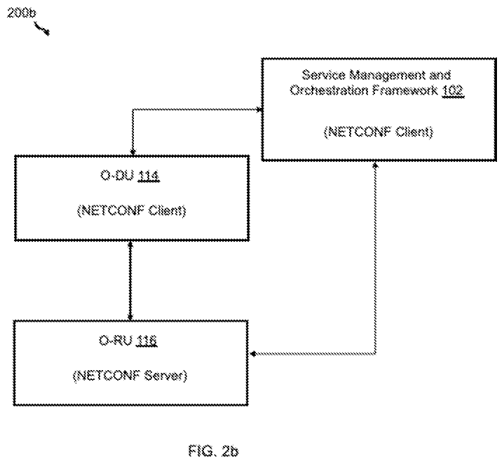

The O-RU 116, which is the NETCONF server herein, may be managed using management models namely Hierarchical model and Hybrid model. FIG. 2a illustrates the hierarchical model 200a and FIG. 2b illustrates the hybrid model 200b.

In the hierarchical model 200a, the O-RU 116 (subordinate O-RU) is managed by the O-DU 114 which in turn is managed by the SMO 102. The O-DU 114 may act as both NETCONF client (to the O-RU) and NETCONF server (to the SMO to reduce processing load), the SMO 102 as NETCONF client and the O-RU 116 as NETCONF server.

In the hybrid model 200b, the O-RU 116 is managed by one or more NMSs or the SMO 102 in addition to the O-DU 114. An advantage of this model is that the SMO 102 can monitor/control other network devices in addition to the O-RU 116 enabling uniform maintenance, monitoring, and control of all. The O-DU 114 and the SMO 102 work as NETCONF client and the O-RU 116 as NETCONF server.

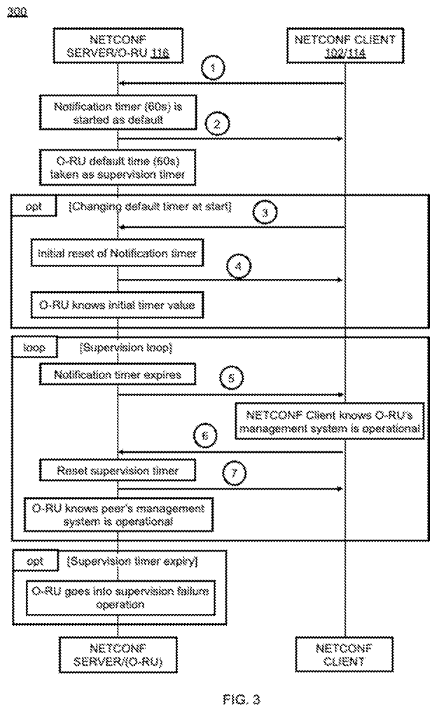

FIG. 3 is sequence diagram 300 for supervising/monitoring connectivity between the NETCONF server (i.e., the O-RU) and the NETCONF client (i.e., the O-DU/SMO). At step 1, when the NETCONF server 116 has established a connection with the NETCONF client (102 or 114) with sudo privileges (known to the person skilled in the art), the NETCONF client automatically sends create subscription for supervision-notification and a notification timer gets activated. The notification timer may have a default time of 60 seconds. The NETCONF client establishes an SSH (Secure Shell) connection with the NETCONF server.

At step 2, the O-RU 116 sends an immediate RPC (Remote Procedure Call) reply message to the NETCONF client, where the O-RU 116 indicates that the default time is taken as a supervision timer or a watchdog supervision timer. Here, the O-RU 116 operates the supervision timer to ensure that it has steady connectivity to the NETCONF client which has sudo access control privileges (known to the person skilled in the art).

At step 3, the NETCONF client transmits supervision-watchdog-reset RPC and the initial reset of the notification timer takes place and at step 4, the NETCONF server (the O-RU) sends next notification timestamp (date-time) in reply, where the O-RU knows the initial timer value.

In the supervision loop, if the notification timer expires, the O-RU sends an empty notification as heartbeat notification to the NETCONF client at step 5. Here, the NETCONF client knows that the O-RU's management system is operational. The O-RU provides NETCONF Notifications to indicate to remote systems that its management system is operational.

At step 6, the NETCONF client sends supervision-watchdog-reset RPC and the supervision timer is reset. When resetting the supervision timer, the NETCONF client may update value for the supervision timer. The NETCONF client can set new value (i.e., the updated value) of the supervision timer without receiving supervision-notification from the O-RU. The updated value is taken into use instantly with respect to supervision-watchdog-reset RPC.

At step 7, the NETCONF server (the O-RU) sends next notification timestamp (date-time) in reply to the NETCONF client. The supervision is intended to be used with the NETCONF client associated with the operation of the peer to the O-RAN Radio's lower layer split.

If the supervision timer expires, the O-RU enters supervision failure condition. Further, if all NETCONF sessions to NECTONF clients with sudo privileges are closed, the O-RU immediately disables operation of the supervision timer.

The session between NETCONF client and NETCONF server can be ended due to two reasons: expiration of supervision watchdog timer (as discussed above) or close-session commanded by the NETCONF client. In both cases, the O-RU 116 enters “supervision failure” condition.

If NETCONF session is ended due to expiration of supervision watchdog timer, the O-RU 116 immediately disables operation of the supervision timer for broken session and starts performing Call Home procedure towards known IP of lost NETCONF client with respect to “re-call-home-no-ssh-timer”. If in result of supervision watchdog timer expiration, the O-RU 116 does not have running NETCONF session with any sudo or hybrid-odu NETCONF client, the O-RU performs autonomous reset.

Further, if NETCONF session is closed by NETCONF client, the O-RU 116 disables operation of the supervision timer for terminated session and starts performing Call Home procedure towards known IP of lost Netconf Client with respect to “re-call-home-no-ssh-timer”. If in result of NETCONF session is terminated by NETCONF Client, the O-RU 116 does not have running NETCONF session with any sudo or hybrid-o-du NETCONF Client, the O-RU 116 repeats Call Home procedure with respect to “re-call-home-no-ssh-timer” timer and “max-call-home-attempts” counter. If connection with at least one sudo or hybrid-odu NETCONF client is not established after certain number of repetitions defined by “max-call-home-attempts” counter, the O-RU 116 performs autonomous reset.

Even after the changes proposed by the existing methodologies, issue arises for a highly available system which should not lead to cease in radio frequency (RF) transmission in case only the hybrid connection to SMO/NMS as sudo is lost but the hierarchical connection to O-CU/O-DU is still operational. Advantageously, the present disclosure resolves the issue as detailed below.

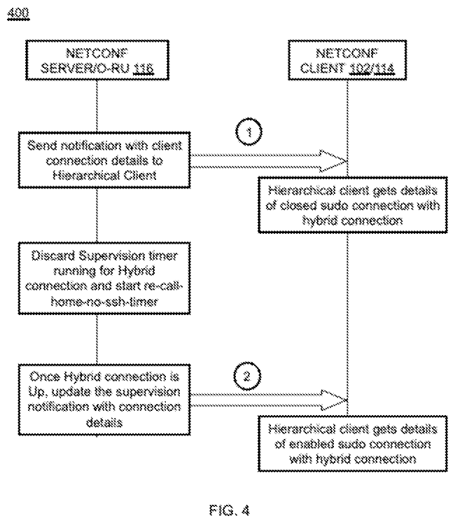

FIG. 4 is sequence diagram 400 illustrating switching between the hierarchical model (shown in FIG. 2a) and the hybrid model (shown in FIG. 2b) during supervision failure (or connection failure). Particularly, FIG. 4 is sequence diagram illustrating switching to the hierarchical model in case of supervision failure with the SMO/NMS (hybrid sudo connection).

In case, if the hybrid sudo connection is broken, at step 1, the O-RU 116 sends notification with hybrid (SMO) client (NETCONF client) and hierarchical client (NETCONF client) connection details to both the clients. The hierarchical client gets details of closed hybrid sudo connection when the connection goes down in the next supervision notification.

Thereafter, the O-RU 116 will discard the supervision timer running for the hybrid connection and start re-call-home-no-ssh-timer (re-establish the connection). Once the hybrid connection is Up, the O-RU will update the supervision notification with connection details of the hybrid client and start sending again to both the clients. At step 2, the hierarchical client gets details of enabled sudo connection with hybrid connection.

The O-RU 116 stores and updates the aforesaid connection details at YANG model. Typically, YANG (Yet Another Next Generation) is a data modelling language used to model configuration and state data manipulated by the NETCONF protocol, NETCONF remote procedure calls, and NETCONF notifications.

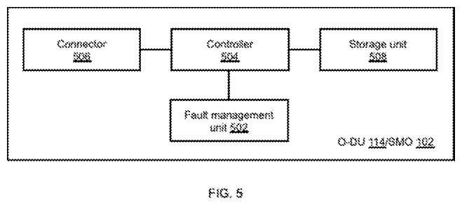

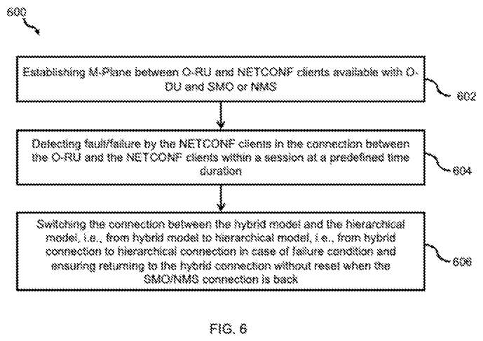

The above steps of FIG. 4 are further explained below in conjunction with FIG. 5 and FIG. 6.

FIG. 5 illustrates various hardware elements of the O-DU/SMO (114/102) to manage O-RU faults and failures through the NETCONF client by the management plane (M-Plane) through the YANG model.

Referring to FIG. 5, various hardware elements of the O-DU/SMO (or NMS) may be a fault management unit (FMU) 502, at least one processor and/or controller 504, a connector 506 and a storage unit 508. However, the components of the O-DU/SMO are not limited to the above-described example, and for example, the O-DU/SMO may include more or fewer components than the illustrated components. In addition, the fault management unit 502, the controller 504, the connector 506 and the storage unit 508 may be implemented in the form of a single chip.

The fault management unit (FMU) 502 may manage the O-RU faults (or supervision failure as discussed above) through the NETCONF client by the M-Plane through the YANG model. To manage the faults, the FMU 502 may establish the M-Plane (using NETCONF Interface(s)) between the O-RU 116 and a plurality of NETCONF clients (i.e., NETCONF clients) available with the O-DU 114 and the SMO 102 or NMS. That is, the O-RU NETCONF Server is configured to interface with the SMO/NMS NETCONF Client.

As described earlier, in the M-Plane, the O-DU 114 and the SMO 102/NMS may manage the O-RU 116 using NETCONF, wherein the O-DU 114 and the SMO/NMS may correspond to NETCONF clients, while the O-RU 116 may correspond to NETCONF server.

In the ORAN 100, management functions of the O-RU 116 are done over the M-Plane. The management functions (or M-plane functions) may include O-RU start-up procedure, O-RU Software management, O-RU parameter set/get (Configuration Management), O-RU measurement (Performance Management), O-RU fault management (Fault Management), O-RU data file send/receive management (File Management), for example.

Additionally, to achieve any other required management operation, the O-RAN fronthaul specifications prescribe various parameters as data models that may be referred.

The NETCONF interface may be established between the SMO/NMS and the O-RU by establishing a transport layer between components of the O-RU (may be one or more O-RUs) and the SMO/NMS via the O-DU 114 and establishing the NETCONF interface between the SMO/NMS NETCONF Client and the O-RU NETCONF Server. The NETCONF interface may comprise at least one of a fault management interface, a software management interface, a configuration management interface and a performance management interface.

The FMU 502 may detect the fault/failure by the NETCONF clients in the connection between the O-RU and NETCONF clients within a session at a predefined time duration. The session may be accompanied by an exchange of messages. As explained earlier, there are two types of connection models for O-RU management: hybrid and hierarchical models, wherein, in connection of the hybrid model, the O-RU 116 is managed by both NETCONF clients (SMO/NMS and O-DU) and the SMO/NMS Client interfaces with the O-DU and the O-RU both and during connection of the hierarchical model, the NETCONF client is configured to network with the O-DU 114 and the O-DU manages the NETCONF server i.e., the O-RU 116.

In case of failure condition/scenario with the hybrid model, the FMU 502 may switch the connection between the hybrid model and the hierarchical model, i.e., from hybrid model to hierarchical model, i.e., from hybrid connection to hierarchical connection, where the session may end between NETCONF client and NETCONF server due to expiration of session at the predefined time duration or session close command received from NETCONF client, for example.

However, while the FMU 502 switches the connection, the FMU 502 ensures returning to the hybrid connection without any reset when the SMO/NMS connection is back. Advantageously, such avoidance of reset saves prior implemented security configuration in the O-RU 116.

Switching of the connection from the hybrid model to the hierarchical model may be done by retrieving information such as information of all lost connections and information of reconnection of the hybrid model to the NETCONF client, stored in the YANG model and deploying the information from the YANG model to the hierarchical model while switching the connection as a setting of required parameters is specified in form of the YANG model.

Further, switching of the connection from the hierarchical model to the hybrid model may be done by retrieving information such as connection details like switching connection details from the YANG model and deploying the information in the hierarchical model.

Accordingly, the O-RU 116 updates connection details of the hybrid client at the YANG model and starts sending again notifications with the connection details to both the NETCONF clients.

The controller 504 may control a series of processes so that the O-DU/SMO/NMS can operate according to description described above. For example, the controller 504 may transmit/receive the connection information through the connector 506. There may be a plurality of controllers 504, and the controller 504 may perform a component control operation of the O-DU/SMO/NMS by executing a program stored in the storage unit 508.

The storage unit 508 may store programs and data necessary for the operation of the O-DU/SMO/NMS. The storage unit 508 may be composed of a storage medium such as read only memory (ROM), random access memory (RAM), hard disk, compact disc ROM (CD-ROM), and digital versatile disc (DVD), or a combination of storage media. Also, there may be a plurality of storage units 508.

The connector 506 may be a device that connects the O-DU/SMO/NMS and the O-RU, and may perform physical layer processing for message transmission and reception.

FIG. 6 is a flowchart 600 illustrating a fault/failure management method for the Open Radio Unit (O-RU) operating in a wireless communication network, i.e., the ORAN 100. It may be noted that in order to explain the method steps of the flowchart 600, references will be made to the elements explained in FIG. 1 through FIG. 5.

The method manages the O-RU faults/failure (supervision failure) through the plurality of NETCONF clients (i.e., the NETCONF clients) by the M-Plane in the ORAN (RAN) environment using the YANG Model.

At step 602, the method includes establishing the M-Plane (using NETCONF Interface(s)) between the O-RU 116 and the NETCONF clients available with the O-DU 114 and the SMO 102 or NMS. At step 604, the method includes detecting the fault/failure by the NETCONF clients in the connection between the O-RU and the NETCONF clients within a session at a predefined time duration. The session may be accompanied by an exchange of messages.

Further, at step 606, the method includes switching the connection between the hybrid model and the hierarchical model, i.e., from hybrid model to hierarchical model, i.e., from hybrid connection to hierarchical connection in case of failure condition/scenario and ensuring returning to the hybrid connection without reset when the SMO/NMS connection is back.

Advantageously, switching the hybrid model to the hierarchical model for NETCONF session avoids reset of the O-RU, thus there is no downtime of the M-Plane.

It may be noted that the flowchart 600 is explained to have above stated process steps; however, those skilled in the art would appreciate that the flowchart 600 may have more/less number of process steps which may enable all the above stated implementations of the present disclosure.

The various actions, acts, blocks, steps, or the like in the flow chart and sequence diagrams may be performed in the order presented, in a different order or simultaneously. Further, in some implementations, some of the actions, acts, blocks, steps, or the like may be omitted, added, modified, skipped, or the like without departing from the scope of the present disclosure.

The embodiments disclosed herein can be implemented using at least one software program running on at least one hardware device and performing network management functions to control the elements.

It will be apparent to those skilled in the art that other embodiments of the invention will be apparent to those skilled in the art from consideration of the specification and practice of the invention. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope of the invention. It is intended that the specification and examples be considered as exemplary, with the true scope of the invention being indicated by the claims.

The methods and processes described herein may have fewer or additional steps or states and the steps or states may be performed in a different order. Not all steps or states need to be reached. The methods and processes described herein may be embodied in, and fully or partially automated via, software code modules executed by one or more general purpose computers. The code modules may be stored in any type of computer-readable medium or other computer storage device. Some or all of the methods may alternatively be embodied in whole or in part in specialized computer hardware.

The results of the disclosed methods may be stored in any type of computer data repository, such as relational databases and flat file systems that use volatile and/or non-volatile memory (e.g., magnetic disk storage, optical storage, EEPROM and/or solid state RAM).

The various illustrative logical blocks, modules, routines, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components or any combination thereof designed to perform the functions described herein. A general-purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “may,” “might,” “may,” “e.g.,” and the like, unless specifically stated otherwise, or otherwise understood within the context as used, is generally intended to convey those certain alternatives include, while other alternatives do not include, certain features, elements and/or steps. Thus, such conditional language is not generally intended to imply that features, elements and/or steps are in any way required for one or more alternatives or that one or more alternatives necessarily include logic for deciding, with or without other input or prompting, whether these features, elements and/or steps are included or are to be performed in any particular alternative. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain alternatives require at least one of X, at least one of Y, or at least one of Z to each be present.

While the detailed description has shown, described, and pointed out novel features as applied to various alternatives, it can be understood that various omissions, substitutions, and changes in the form and details of the devices or algorithms illustrated can be made without departing from the scope of the disclosure. As can be recognized, certain alternatives described herein can be embodied within a form that does not provide all of the features and benefits set forth herein, as some features can be used or practiced separately from others.

We claim:

1. A method for managing Open Radio Unit (O-RU) (116) supervision failure through a plurality of NETCONF (Network Configuration Protocol) clients by a management-plane (M-Plane) in an open radio access network (ORAN) (100) comprising:
upgrading the established M-Plane between the O-RU (116) and the plurality of NETCONF clients available with each of an Open Distributed Unit (O-DU) (114) and a Service Management and Orchestration (SMO) framework (102), wherein management function of the M-Plane includes software management, fault management, configuration management, performance management and file management;
detecting supervision failure by the plurality of NETCONF clients in the connection between the O-RU (116) and the plurality of NETCONF clients within a session at a predefined time duration, the session is accompanied by an exchange of messages, wherein the O-DU (114) and the SMO framework (102) manage the O-RU (116) in the M-Plane using NETCONF, wherein the O-DU (114) and the SMO framework (102) each corresponds to a NETCONF client while the O-RU (116) corresponds to a NETCONF server; and
switching the connection from a hybrid model to a hierarchical model in case of the failure with the hybrid model, whereby switching the connection ensures returning to the hybrid model without reset when connection of the SMO framework is back, thereby saving a prior implemented security configuration in the O-RU (116),
wherein, in connection of the hierarchical model a NETCONF client is configured to network with the O-DU (114) and the O-DU (114) manages the NETCONF server and in connection of the hybrid model, the O-RU (116) is managed by the plurality of NETCONF clients each corresponding to the O-DU (114) and the SMO framework (102); and SMO Client interfaces with the O-DU and the O-RU both.

2. The method as claimed in claim 1, wherein switching the connection from the hybrid model to the hierarchical model when the O-RU enters in failure condition, wherein the session ends between the NETCONF client and the NETCONF server due to expiration of the session at the predefined time duration and a session close command received from the NETCONF client.

3. The method as claimed in claim 2, wherein switching the connection from the hybrid model to the hierarchical model comprising:
retrieving information of all lost connections and information of reconnection of the hybrid model to the NETCONF client stored in a YANG (Yet Another Next Generation) model; and
deploying the information from the YANG model to the hierarchical model while switching the connection as a setting of required parameters is specified in form of the YANG model.

4. The method as claimed in claim 1 further comprising:
switching the connection from the hierarchical model to the hybrid model when the connection of the SMO framework is back.

5. The method as claimed in claim 4, wherein switching the connection from the hierarchical model to the hybrid model comprising:
retrieving connection details from the YANG model; and
deploying the connection details in the hierarchical model.

6. The method as claimed in claim 1 further comprising:
updating the connection details of the NETCONF client of the SMO framework (102) at the YANG model of the O-RU (116); and
sending notifications with the connection details to the plurality of NETCONF clients.

7. The method as claimed in claim 1, wherein establishing the connection via a NETCONF interface, the NETCONF interface comprising at least one of: a fault management interface, a software management interface, a configuration management interface and a performance management interface.

8. The method as claimed in claim 1, wherein the NETCONF server of the O-RU (116) interfaces with the NETCONF client of the SMO framework (102).

9. The method as claimed in claim 1, wherein establishing the NETCONF interface between the SMO framework (102) and the O-RU (116) comprising:
establishing a transport layer between the O-RU and the SMO framework via the O-DU; and
establishing the NETCONF interface between the NETCONF client of the SMO framework and the NETCONF server of the O-RU.
